(19) United States
(12) Patent Application Publication
(10) Pub. No.: US 2003/0206590 A1
(43) Pub. Date: Nov. 6, 2003

(54) MPEG transcoding system and method using motion information

(75) Inventor: Santhana Krishnamachari, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/139,174

(22) Filed: May 6, 2002

(51) Int. Cl. H04N 7/12

(52) U.S. Cl. 375/240.16; 375/240.24; 375/240.2

(57) ABSTRACT

An open loop system and method of transcoding a stream of compressed video data to a required lower bit rate. The invention includes the steps of: examining motion vectors for each of a set of macroblocks in the stream; determining an importance of each of the set of macroblocks based the motion vectors; and selectively modifying DCT blocks in the set of macroblocks to reduce the bit rate, wherein the modification to each DCT block is based on the determined importance of the macroblock. High coefficient dropping or re-quantization may be utilized.

### BACKGROUND OF THE INVENTION

1. Technical Field

The present invention relates generally to transcoding compressed data streams, and more particularly relates to open loop system and method of bit rate transcoding MPEG data using motion information.

2. Related Art

As the popularity of systems utilizing compressed data standards, such as MPEG-2, MPEG-4, H.261, H.263, etc., continues to grow, the ability to efficiently process and communicate compressed data remains an ongoing challenge. One particular challenge arises when the bit rate of a stream of compressed data must be lowered, for instance, in order to meet the bandwidth demands of a new transmission channel. The process of reducing the bit rate is referred to as transcoding, and more specifically bit rate transcoding.

Within each frame of compressed video data, picture information is stored in macroblocks comprised of 16×16 pixel blocks, which are made up of many 8×8 DCT (discrete cosine transform) blocks.

In the present state of the art, open loop and closed loop systems exist to transcode an MPEG stream to a lower bit rate. Closed loop systems function by decoding (or partially decoding) and then re-encoding the bitstream at a lower rate. Closed loop systems generally provide better quality, but are computationally complex to implement. Accordingly, closed loop systems are often too costly for many applications.

Open loop systems perform bit rate transcoding without fully decoding the original stream. Rather, open loop systems manipulate the compressed data to allow for a lower bit rate. Known transcoding techniques for bit rate reduction include: (1) re-quantizing the discrete cosine transform (DCT) coefficients with a larger quantizer, and (2) dropping one or more high frequency coefficients. Both methods are fairly simple from a computational standpoint, and therefore provide a cost effective alternative to closed loop systems. However, open loop can result in substantial error drift due to the motion compensated coding used by, e.g., the MPEG standards. In particular, any error introduced by the above mentioned open loop bit rate reduction methods that occurs in a reference frame will propagate to other frames.

Accordingly, a need exists for an open loop bit rate transcoding system that will reduce error drift typically associated with open loop transcoding.

### SUMMARY OF THE INVENTION

The present invention address the above mentioned problems, as well as others, by providing an open loop transcoding system that examines motion information (e.g., motion vectors) to decide the importance of each macroblock. The importance information is then used to selectively apply a transcoding algorithm to each macroblock in order to reduce error propagation. In a first aspect, the invention provides a system for converting a stream of compressed video data to a required lower bit rate, comprising: a system for determining an importance of each of a set of macroblocks in the stream; and a system for selectively bit rate transcoding DCT blocks in the set macroblocks based on the determined importance of each macroblock.

In a second aspect, the invention provides a program product stored on a recordable medium for bit rate transcoding a stream of compressed video data to a required lower bit rate, the program product comprising: means for determining an importance of each of a set of macroblocks in the stream; and means for selectively modifying DCT coefficients in blocks contained in the set of macroblocks to reduce the bit rate, wherein the modification to each macroblock is based on the determined importance of the macroblock.

In a third aspect, the invention provides a method of transcoding a stream of macroblock data to a required lower bit rate, the comprising: examining motion vectors for each of a set of macroblocks in the stream; determining an importance of each of the set of macroblocks based the motion vectors; and selectively modifying DCT coefficients in blocks contained in the set of macroblocks to reduce the bit rate, wherein the modification to each macroblock is based on the determined importance of the macroblock.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a transcoding system in accordance with the invention.

FIG. 2 depicts a P frame analysis in accordance with the present invention.

FIG. 3 depicts an I frame analysis in accordance with the present invention.

FIG. 4 depicts an indirect analysis in accordance with the present invention.

FIG. 5 depicts a partial reference block analysis in accordance with the present invention.

FIG. 6 depicts an exemplary allocation of reduction among a set of macroblocks.

### DETAILED DESCRIPTION OF THE INVENTION

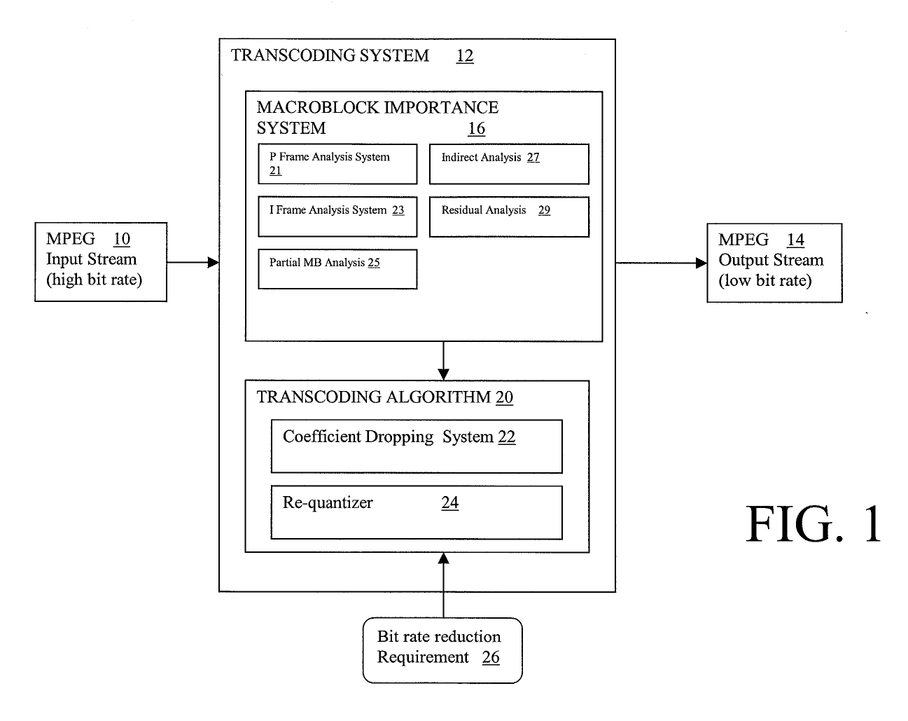

Referring now to the figures, FIG. 1 depicts a bit rate transcoding system 12 for reducing the bit rate of an input stream of MPEG data 10 from high bit rate to an output stream 14 having a lower bit rate. For example, bit rate transcoding system 12 might cause the bit rate to be reduced from 4 Mbits/second to 2 Mbits/sec, a 50% reduction. The amount of bit rate reduction is determined by bit rate reduction requirement 26, which can be inputted/determined in any manner, e.g., requirement 26 can be set to a predetermined level, can change dynamically based on system conditions, etc. It should be understood that the invention could be applied to any type of motion compensation based data stream, including MPEG-2, MPEG-4, H.261, H.263, etc.

Transcoding system 12 includes a macroblock importance system 16 that determines the importance of inputted macroblocks based, for instance, on motion information. Specifically, macroblock importance system 16 may include a system that examines motion vectors in the inputted MPEG stream 10 to calculate an importance of each macroblock within each inputted reference frame (i.e., P and I frames). Importance is calculated by determining the number of target macroblocks for which the current macroblock is used as a reference macroblock. Macroblocks that are used more frequently as reference blocks are identified as more important than others that are used less frequently as reference blocks. In an exemplary embodiment, each macroblock may be assigned an importance factor.

Macroblock importance system 16 can assess an importance factor to each such macroblock in any desirable manner. In a simple case, the importance factor could equal the number of target macroblocks that reference the current macroblock. Thus, for instance, if an inputted macroblock was used as a reference macroblock four times, then the inputted macroblock would be given an importance factor of four. Alternatively, an inputted macroblock could be assigned to a range, e.g., low, medium and high, based on how often it was used as a reference macroblock. Thus, for instance, if the inputted macroblock was used as a reference macroblock zero times, it may be assigned a low importance factor; if it was used as a reference block one or two times, it may be assigned a medium importance factor; and if it was used as a reference block three or more times, it may be assigned a high importance factor. Obviously, other variations could be used.

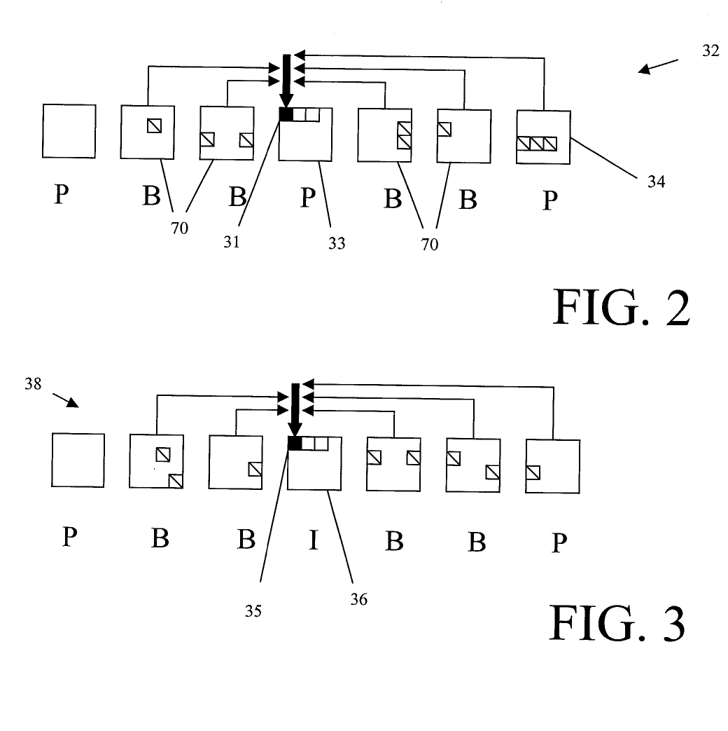

Macroblock importance system 16 may include a P frame analysis system 21; an I frame analysis system 23; a partial macroblock analysis system 25; an indirect analysis system 27; and a residual analysis system 29. P frame analysis system 21 and I frame analysis system 23 examine macroblocks within P and I frames, respectively, to determine the relative importance of the macroblock data. Specifically, when a P or I frame is analyzed, system 21 or 23 examines each macroblock, and a relative importance factor is calculated for each macroblock. As noted above, importance is based on how often the current macroblock acts as a reference macroblock or partial reference block. (Note that for the purposes of this invention, the term “reference macroblock” may comprise a complete or partial reference block.) Because P and I frames are used for forward and backward prediction, P frame analysis system 21 and I frame analysis system 23 analyze the motion vectors of previous and subsequent B frames, and a subsequent P frame (if applicable), to determine how often a current macroblock within either a P or I frame acts as a reference macroblock. An importance factor is determined based on the number of target macroblocks that reference the current macroblock in either the P or I frame (i.e., the number of predictions). Examples of this process are described below with reference to FIGS. 2 and 3. (Note that certain P frames are followed by I frames, and therefore will not have a subsequent P frame to analyze.)

It should be appreciated that macroblock importance system 16 can analyze individual macroblocks for their relative importance or sets of macroblocks (e.g., an entire frame or even a set of frames such as a group of pictures). In the case where sets of macroblocks are being analyzed for their importance, macroblock importance system 16 would first group sets of macroblocks together based on a predetermined scheme. The importance factor of the set is then determined by combining (e.g., summing, weighting, etc.) the importance factors of each macroblock in the set. Priority is thus decided, for instance, based on cumulative importance of the macroblocks in each set.

Macroblock importance system 16 may further comprise a partial macroblock analysis system 25 that analyzes macroblock importance when reference macroblocks do not exactly coincide with the current macroblock being analyzed (i.e., when a current macroblock acts a partial reference block). Specifically, in cases where only part of a current macroblock is used as the reference macroblock, partial macroblock analysis system 25 computes the overlap (in terms of pixels) between the current macroblock and the reference macroblock. Thus, for example, if there were an overlap of 128 of 256 pixels, the importance factor would be scaled by 50%. An example of this is described below with respect to FIG. 5.

An exemplary algorithm for calculating an importance factor of a macroblock in a P frame would be as follows:

read a current macroblock;
set importance_value (of the current macroblock) = 0;
identify target macroblocks in B frames and the subsequent P frame that reference

the current macroblock;

for each identified target macroblock:

examine the corresponding reference macroblock;
if the reference macroblock exactly coincides with the current macroblock,

then importance_value = importance_value + 1;

else

compute pixel overlap (maximum is 16×16=256);
importance_value = importance_value + (pixel overlap/256);

end.

As an alternate embodiment, macroblock importance system 16 may also include an indirect analysis system 27 that examines subsequent indirect predictions in determining importance. Indirect analysis system 27, while more computationally expensive, provides a more accurate valuation scheme. For example, in MPEG coding, macroblocks in I frames are used to “directly” predict P frame macroblocks, which in turn are used to “indirectly” predict subsequent P frame macroblocks and B frame macroblocks, and so forth. So in computing the importance of an I or a P frame macroblock, macroblock importance system 16 may be used to not only examine direct predictions, but also examine subsequent indirect predictions. Thus, if an I macroblock acts as a reference for motion prediction for a macroblock in a P frame (direct prediction), and subsequently the P frame macroblock acts as a reference for other macroblocks in subsequent P and B pictures (indirect prediction), the importance factors of the indirect predictions can be added, or otherwise factored into the importance factors of the direct prediction. Accordingly, the relative importance among and between macroblocks in both I and P frames can be computed and prioritization can be based on such results.

As a further alternate embodiment, the importance factor can be calculated (or further calculated) by residual analysis system 29 based on discrete cosine transform (DCT) residual values. A residual is the difference between a target macroblock and a reference macroblock. Thus, the smaller the residual, the closer the target macroblock matches the reference macroblock, and the greater the importance. Accordingly, residual analysis system 29 can examine the residual of each identified target macroblock and compute a function of each residual (e.g., the absolute or weighted sum of the coefficients). The importance factor of the current macroblock can then be calculated based on, for example, a cumulative value of the residual computations from each target macroblock. It should be appreciated that this embodiment can be combined or used separately from the other embodiments described herein.

In an exemplary embodiment, since B frames are not used as references in predictive coding, the macroblocks in B frames are assigned the lowest importance. The macroblocks in the P frames are then assigned a relative higher importance, with the individual P frame macroblock data being valued in the manner described above. Finally, the macroblocks in the I frames are assigned the highest importance, again with the macroblock data being valued based on the methods discussed above.

Referring now to FIG. 2, an example of how an importance value is calculated for a P frame macroblock is shown. A stream of MPEG video data 32 is depicted comprised of a sequence of frames (P, B, B, P, B, B, P). In accordance with the methods discussed above, the macroblock data within P frame 33 is being analyzed for its importance. Specifically, a current macroblock 31 is examined (as shown by the arrows) to determine how often the current macroblock 31 acts as a reference macroblock for target macroblocks in previous and subsequent B frames 70, and target macroblocks in the subsequent P frame 34. As can be seen, current macroblock 31 acts as a reference macroblock for nine target macroblocks (shown as squares with a diagonal line). The target macroblocks could be any one of the 16×16 blocks (not shown) in the neighboring frames 70 and 34. Assuming exact coincidence between the current macroblock 31 and the corresponding reference macroblock, the macroblock would be assigned an importance value of nine. Accordingly, macroblock 31 would be assigned a relative priority based on this value as compared to the other macroblocks in P frame 33. Note that in this case a subsequent P frame 34 follows P frame 33. In other cases (not shown), P frame 33 may be followed by an I frame, in which cases the subsequent I frame would not be analyzed for target macroblocks.

Referring now to FIG. 3, a similar example of how an importance value is calculated for an I frame macroblock is shown. In this case, a stream of frames 38 (P, B, B, I, B, B, P) is shown, and the macroblock data of I frame 36 is being analyzed to determine the relative priority of each macroblock in I frame 36. Here again, target macroblocks are identified by examining the motion vectors in the subsequent P frame and neighboring B frames. In this case, there are eight target macroblocks that are predicted by the current macroblock. Assuming exact coincidence between current macroblock 35 and the corresponding reference macroblock, an importance value of eight would be assigned to the current macroblock 35.

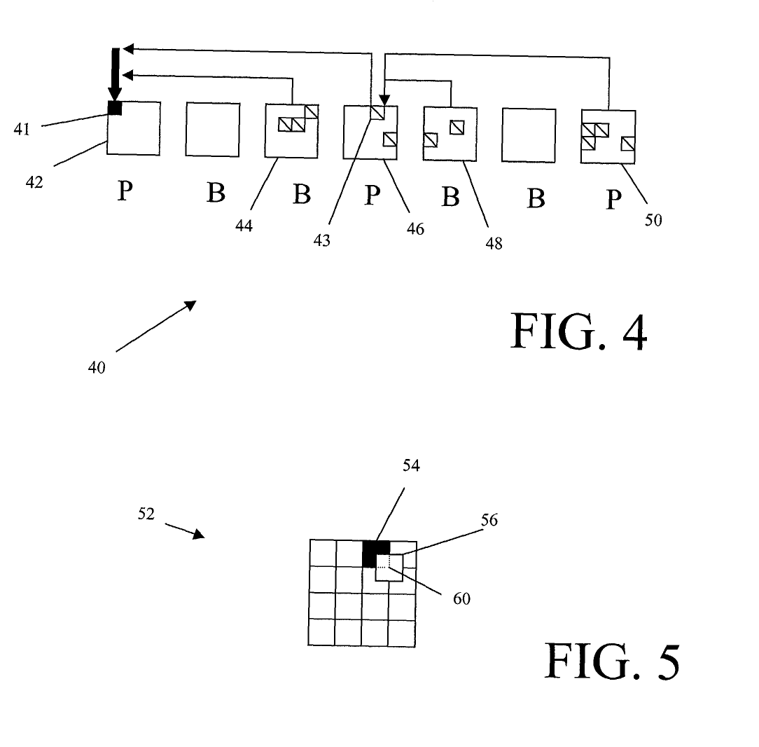

Referring now to FIG. 4, an example is shown of how an importance value is calculated for an alternate embodiment utilizing indirect analysis system 27. Specifically, a stream of frames 40 (P, B, B, P, B, B, P) is shown, with the macroblock data in P frame 42 being analyzed to determine relative priority. It can be seen that a current macroblock 41 acts as a reference macroblock for a total of five target macroblocks in both B frame 44 and P frame 46. In addition, the target macroblock 43 in P frame 46 further acts as an “indirect” reference macroblock for a total of six indirect target macroblocks in B frame 48 and P frame 50. Assuming no other target macroblocks in P frame 46 act as reference macroblocks, the importance value for current macroblock 41 of P frame 42 would be eleven. Although not shown, a more complex chain of indirect calculations could be utilized. For example, the target macroblocks in P frame 50 could be further examined to determine how often they act as reference macroblocks, etc.

Referring now to FIG. 5, an example is shown of how a partial reference block is taken into account by partial macroblock analysis system 25. Specifically, frame 52 (e.g., I or P) includes a current macroblock 54 that is being analyzed for importance, a reference macroblock 56 that does not exactly coincide with current macroblock 54, and an overlap portion 60 that represents the portion where macroblock 54 and reference macroblock 56 coincide. In this example, only 25% of the pixels in the current macroblock 54 are used as a reference macroblock for target macroblocks in other frames. Thus, the importance value for this particular macroblock would be scaled (e.g., by 25%) to account for the overlap.

Once an importance factor has been determined, transcoding algorithm 20 can be selectively applied to one or more macroblocks to reduce the effective bit rate of the input stream 10. The amount of bit rate reduction applied by transcoding algorithm 20 to a given macroblock will generally be inversely proportional or related to the importance factor assigned to the macroblock. Thus, for example, if the macroblock had a high importance factor, then little or no bit rate reduction would be applied to the macroblock. Alternatively, if the macroblock had a low importance factor, then a higher amount of bit rate reduction could be applied to the macroblock.

The actual amount of bit rate reduction for each macroblock will also depend on the inputted bit rate reduction requirement 26. For example, a bit rate reduction requirement 26 of 2 Mbits/sec would require more reduction to each macroblock than a bit rate reduction requirement 26 of 1 Mbits/sec. Thus, the amount of bit rate reduction applied to each macroblock is a function of both the importance factor assigned to the macroblock and the bit rate reduction requirement 26 called for in transcoding the MPEG input stream 10.

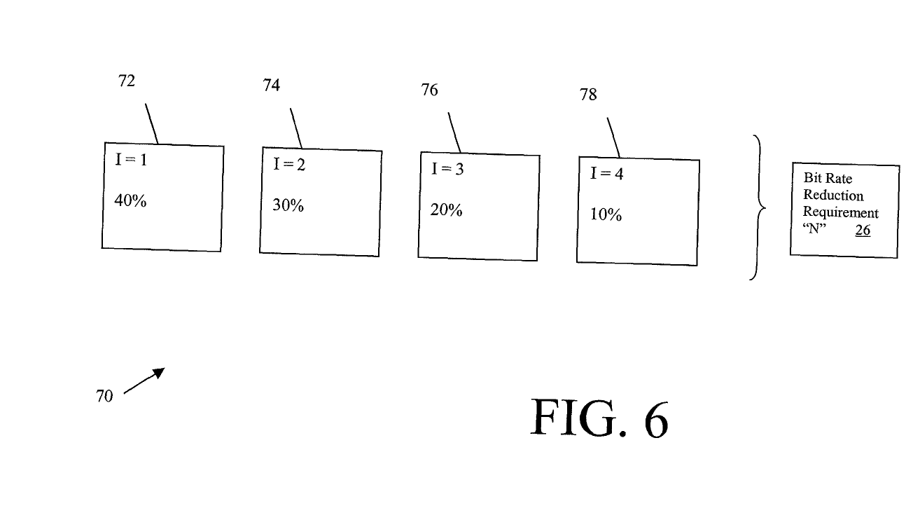

As a simple example, consider the case of four macroblocks shown in FIG. 6. As shown, there is a set 80 of macroblocks 82, 84, 86, 88. Assume that macroblock 82 was assigned an importance factor I=1 (relatively low); macroblock 84 was assigned an importance factor I=2; macroblock 86 was assigned an importance factor I=3; and macroblock 88 was assigned an importance factor I=4 (relatively high). Assume also that there was an inputted bit rate reduction requirement “N” to be applied to the set 80 of macroblocks. To achieve a bit rate reduction in a selective manner that is proportional to the macroblock importance, transcoding algorithm 20 could cause 40% of the reduction to come from macroblock 82; 30% of the reduction to come from macroblock 84; 20% of the reduction to come from macroblock 86; and 10% of the reduction to come from macroblock 88. Obviously, the actual implementation, e.g., number of macroblocks in the set 80, the allocation of bit reduction percentages, etc., could be implemented in any manner without departing from the scope of this invention. It should also be recognized that the use of percentages to allocate bit rate reduction for each macroblock is for exemplary purposes only, and that any mechanism, measurement, or calculation for allocating bit rate reduction among macroblocks could be utilized.

Once the amount of bit rate reduction is determined for each macroblock, transcoding algorithm 20 may modify the DCT blocks contained in the macroblock data in any fashion to achieve the reduction. Two exemplary reduction systems the modify macroblock data are: (1) coefficient dropping system 22; and (2) re-quantizer 24. Coefficient dropping system 22 causes high frequency coefficients to be dropped from the macroblock to reduce the size, and therefore bandwidth requirement, of the macroblock. Re-quantizer 24 causes DCT coefficients to be to be re-quantized, e.g., with a larger quantizer. As is known, when the quantizer is increased, the precision, and therefore bandwidth requirements, of the DCT coefficients is lowered.

Because the reduction is applied selectively (i.e., greater bit rate reduction applied to less important macroblocks), the error drift associated with open loop transcoding is greatly reduced. Specifically, because macroblocks that are most often used as reference macroblocks receive a lower amount of reduction, there will be less instances of error propagation.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for converting a stream of compressed video data to a required lower bit rate, comprising:
a system for determining an importance of each of a set of macroblocks in the stream; and
a system for selectively bit rate transcoding discrete cosine transform (DCT) blocks in the set of macroblocks based on the determined importance of each macroblock.

2. The system of claim 1, wherein the system for selective bit rate transcoding is further based on a bit rate reduction requirement.

3. The system of claim 1, wherein the importance of each macroblock is based on a number of target macroblocks for which the macroblock was used as a reference macroblock.

4. The system of claim 3, wherein the importance of each macroblock is obtained by examining motion vectors in the stream of data.

5. The system of claim 4, wherein the system for selective bit rate transcoding achieves a reduced bit rate by dropping high frequency coefficients from the DCT blocks based on the importance of the macroblock.

6. The system of claim 5, wherein the system for selective bit rate transcoding drops a greater number of high frequency coefficients from the DCT blocks of less important macroblocks relative to more important macroblocks.

7. The system of claim 5, wherein the number of high frequency coefficients dropped from DCT blocks in a selected macroblock is inversely proportional to the importance of the selected macroblock.

8. The system of claim 4, wherein the system for selective bit rate transcoding lowers the bit rate by re-quantizing DCT coefficients from DCT blocks in a selected macroblock.

9. The system of claim 8, wherein an amount of re-quantization applied to the DCT blocks is based on the importance of the selected macroblock.

10. The system of claim 8, wherein lesser important macroblocks are given a greater amount of re-quantization.

11. The system of claim 1, wherein the system for determining importance includes a P frame analysis system that examines motion vectors from previous and subsequent B frames, and from a subsequent P frame if it exists, to determine how often each macroblock in a current P frame acts as a reference macroblock.

12. The system of claim 11, wherein the system for determining importance further comprises an indirect analysis system that determines how often macroblocks in the subsequent P frame are referenced by other video frames.

13. The system of claim 1, wherein the system for determining importance includes an I frame analysis system that examines motion vectors from previous and subsequent B frames, and from a subsequent P frame, to determine how often each macroblock in a current I frame acts as a reference macroblock.

14. The system of claim 13, wherein the system for determining importance further comprises an indirect analysis system that determines how often target macroblocks in the subsequent P frame act as reference macroblocks.

15. The system of claim 11, further comprising a partial macroblock analysis system that computes an overlap between a current macroblock and a reference macroblock and scales the importance value based on the overlap.

16. The system of claim 1, further comprising a residual analysis system that further determines the importance of each macroblock based on values of a plurality of residual discrete cosine transform (DCT) coefficients of the macroblock.

17. A program product stored on a recordable medium for bit rate transcoding a stream of compressed video data to a required lower bit rate, the program product comprising:
means for determining an importance of each of a set of macroblocks in the stream; and
means for selectively modifying discrete cosine transform (DCT) blocks contained in the set of macroblocks to reduce the bit rate, wherein the modification to each DCT block is based on the determined importance of the macroblock.

18. The program product of claim 17, wherein the modification is further based on a predetermined bit rate reduction requirement for the stream of compressed video data.

19. The program product of claim 17, wherein the importance of each macroblock is based on a number of target macroblocks for which the macroblock was used as a reference macroblock.

20. The program product of claim 19, wherein the importance of each macroblock is obtained by examining motion vectors in the stream of compressed video data.

21. The program product of claim 20, wherein the means for selectively modifying DCT blocks achieves a reduced bit rate by dropping high frequency coefficients from DCT blocks based on the importance of the macroblock.

22. The program product of claim 21, wherein the means for selectively modifying DCT blocks drops a greater number of high frequency coefficients from DCT blocks of less important macroblocks than it drops from more important macroblocks.

23. The program product of claim 21, wherein the number of high frequency coefficients dropped from each DCT block in each macroblock is inversely related to the importance of the macroblock.

24. The program product of claim 20, wherein the means for selectively modifying DCT blocks lowers the bit rate by re-quantizing DCT coefficients from selected macroblocks in the reference frame.

25. The program product of claim 25, wherein an amount of re-quantization applied to each DCT block is based on the importance of the macroblock.

26. The program product of claim 25, wherein lesser important macroblocks are given a greater amount of re-quantization.

27. A method of transcoding a stream of compressed video data to a required lower bit rate, the comprising:
examining motion vectors for each of a set of macroblocks in the stream;
determining an importance of each of the set of macroblocks based the motion vectors; and
selectively modifying discrete cosine transform (DCT) blocks in the set of macroblocks to reduce the bit rate, wherein the modification to each DCT block is based on the determined importance of the macroblock.

28. The method of claim 27, wherein the importance a current macroblock is based on a number of target macroblocks for which the current macroblock was used as a reference macroblock.

29. The method of claim 27, wherein the step of selectively modifying macroblocks includes the step of dropping high frequency coefficients.

30. The method of claim 28, wherein the step of selectively modifying DCT blocks includes the further step of:
dropping more high frequency coefficients for lesser important macroblocks than are dropped for greater important macroblocks.

31. The method of claim 27, wherein the determining step includes the steps of:
reading a current P frame; and
examining motion vectors from previous and subsequent B frames, and from a subsequent P frame if it exists, to determine how often each macroblock in the current P frame acts as a reference macroblock for target macroblocks in the B and P frames.

32. The method of claim 31, wherein the determining step comprises the further step of determining how often target macroblocks in the subsequent P frame act as reference macroblocks.

33. The method of claim 27, wherein the determining step includes the steps of:
reading a current I frame; and
examining motion vectors from previous and subsequent B frames, and from a subsequent P frame, to determine how often each macroblock in the current I frame acts as a reference macroblock for target macroblocks in the B and P frames.

34. The method of claim 33, wherein the determining step comprises the further step of determining how often target macroblocks in the subsequent P frame act as reference macroblocks.

35. The method of claim 27, comprising the further step of assigning B frame data a lowest relative importance.

36. The method of claim 27, wherein if a current macroblock acts as a partial reference macroblock, implementing the steps of:
determining an amount of pixel overlap between the current macroblock and a corresponding reference macroblock; and
scaling the importance of the current macroblock based on the amount of pixel overlap.

37. The method of claim 27, wherein the importance of each macroblock is further determined based on values of a plurality of residual DCT coefficients of the macroblock.
